(19) United States
(12) Patent Application Publication
(10) Pub. No.: US 2023/0363049 A1
(43) Pub. Date: Nov. 9, 2023

(54) METHOD AND DEVICE FOR PERFORMING SIDELINK TRANSMISSION AND RECEPTION

(71) Applicant: ZTE Corporation, Shenzhen (CN)

(72) Inventors: Wei Luo, Shenzhen (CN); Lin Chen, Shenzhen (CN)

(73) Assignee: ZTE Corporation, Shenzhen (CN)

(21) Appl. No.: 18/352,086

(22) Filed: Jul. 13, 2023

Related U.S. Application Data
(63) Continuation of application No. PCT/CN2021/071689, filed on Jan. 14, 2021.

(51) Int. Cl. H04W 76/28; H04W 28/02

(52) U.S. Cl. CPC H04W 76/28; H04W 28/0268; H04W 92/18

(57) ABSTRACT

This disclosure relates to methods and devices for sidelink communication between user equipment in a wireless communication network. A method may include an upper layer of a first UE providing to a lower layer discontinuous reception (DRX) configuration assistance information, the first UE transmitting the DRX configuration assistance information to a second UE, and receiving back DRX configuration information. Another method includes a second UE receiving DRX configuration information from the first UE and determining accept or reject it, wherein the second UE can transmit to the first UE acceptance or rejection information. Another method includes receiving from the network a DRX setting indicating whether a DRX configuration is set by the network, the first UE, or the second UE. Another method includes receiving second DRX configuration information and determining third DRX configuration information based on the second and first DRX configuration information.

### TECHNICAL FIELD

This disclosure is directed generally to wireless communications, and particularly to sidelink communication between communication terminals.

### BACKGROUND

Sidelink (SL) is a unilateral wireless communication service, i.e., the communication between the communication terminals or user equipment (UE). Vehicle networking refers to a large scale system for wireless communication and information exchange among vehicles, pedestrians, roadside equipment, and internet in accordance with agreed communication protocols and data exchange standards. The vehicle networking communications enable the vehicles to gain driving safety, improve traffic efficiency, and acquire convenience or entertainment information. The vehicle networking communication may be categorized into three types as per the objects of wireless communication: the communication between vehicles, i.e., vehicle-to-vehicle (V2V); the communication between vehicles and roadside equipment/network infrastructures, i.e., vehicle-to-infrastructure/vehicle-to-network (V2I/V2N); and the communication between vehicles and pedestrians, i.e., vehicle-to-pedestrian (V2P). These types of communications collectively are referred to as vehicle-to-everything (V2X) communication.

In the V2X communication research of 3rd Generation Partnership Project (3GPP), the sidelink based V2X communication between user equipment is one of the manners to implement the V2X standard, in which traffic data is directly transmitted from a source UE to a destination UE via an air interface without forwarding by the base station and the core network. This V2X communication is referred to as PC5-based V2X communication or V2X sidelink communication.

With the technology advancement and development of the automation industry, the scenarios for V2X communications are further diversified and require higher performance. The advanced V2X services include vehicle platooning, extended sensors, advanced driving (semi-automated driving and full-automated driving), and remote driving. The desired performance requirements may include: supporting data packet with the size of 50 to 12000 bytes, transmission rate with 2 to 50 messages per second, the maximum end-to-end delay of 3 to 500 milliseconds, reliability of 90% to 99.999%, data rate of 0.5 to 1000 Mbps, as well as transmission range of 50 to 1000 meters.

### SUMMARY

In one embodiment, a method performed by a first user equipment in a wireless communication network includes providing, by an upper layer of the first UE to a lower level of the first UE, discontinuous reception (DRX) configuration assistance information, optionally along with at least one of a layer-2 ID, an identification of another UE, quality of service (Qos) information, or a Qos flow identity, and transmitting to a second UE the DRX configuration assistance information. The method also includes receiving, by the first UE from the second UE, DRX configuration information comprising DRX-related parameters for a sidelink communication between the first UE and the second UE or between a pair of source layer-2 ID and destination layer-2 ID. The lower level of the first UE 102 may be the AS level of the first UE 102. Then, the first UE 102 may perform sidelink reception on the time occasion according to the DRX configuration information.

In another embodiment, a method performed by a first user equipment in a wireless communication network includes providing, by an upper layer of the first UE to a lower level of the first UE, discontinuous reception (DRX) cycle, optionally along with at least one of a layer-2 ID, an identification of another UE, quality of service (Qos) information, or a Qos flow identity. The method also includes receiving, by the first UE from the network, multiple DRX configuration information comprising DRX-related parameters for different DRX cycle for a sidelink communication for unicast, groupcast or broadcast. The first UE determines the DRX-related parameters based on the DRX cycle. The lower level of the first UE 102 may be the AS level of the first UE 102. Then, the first UE may perform sidelink reception on the time occasion according to the DRX configuration information.

In another embodiment, a method performed by a second UE includes receiving, from a first UE, DRX configuration information, and determining, by the second UE, to at least one of accept or reject the DRX configuration information from the first UE. The method also includes transmitting, by the second UE to the first UE, at least one of acceptance information indicating an acceptance of the DRX configuration information or rejection information indicating a rejection of the DRX configuration information.

In another embodiment, a method includes receiving, by the first UE from the network, a DRX setting indicating whether a DRX configuration scheme for a sidelink communication between the first UE and a second UE is to be set by the network, the first UE, or the second UE. In yet another embodiment, a method includes receiving, from a second UE, second DRX configuration information comprising second DRX-related parameters of the second UE, and determining, by the first UE, third DRX configuration information based on the second DRX configuration information and first DRX configuration information comprising first DRX-related parameters of the first UE.

In another embodiment, a device for wireless communication may include a memory storing instructions and a processing circuitry in communication with the memory. When the processing circuitry executes the instructions, the processing circuitry is configured to carry out the above method.

In another embodiment, a computer-readable medium comprising instructions which, when executed by a computer, cause the computer to carry out the above method.

The above and other aspects and their implementations are described in greater detail in the drawings, the descriptions, and the claims below.

### BRIEF DESCRIPTION OF THE DRAWINGS

FIG. 1 illustrates an example diagram of a wireless communication network in accordance with various embodiments.

FIG. 2 illustrates a flow diagram of a method for sidelink communication in accordance with various embodiments.

FIG. 3 illustrates another flow diagram of a method for sidelink communication in accordance with various embodiments.

FIG. 4 illustrates another flow diagram of a method for sidelink communication in accordance with various embodiments.

FIG. 5 illustrates another flow diagram of a method for sidelink communication in accordance with various embodiments.

### DETAILED DESCRIPTION

The technology and examples of implementations and/or embodiments in this disclosure can be used to improve performance in wireless communication systems. The term “exemplary” is used to mean “an example of” and unless otherwise stated, does not imply an ideal or preferred example, implementation, or embodiment. Section headers are used in the present disclosure to facilitate understanding and do not limit the disclosed technology in the sections only to the corresponding section. Please note that the implementations may, however, be embodied in a variety of different forms and, therefore, the covered or claimed subject matter is intended to be construed as not being limited to any of the embodiments to be set forth below. Please also note that the implementations may be embodied as methods, devices, components, or systems. Accordingly, embodiments of this disclosure may, for example, take the form of hardware, software, firmware or any combination thereof.

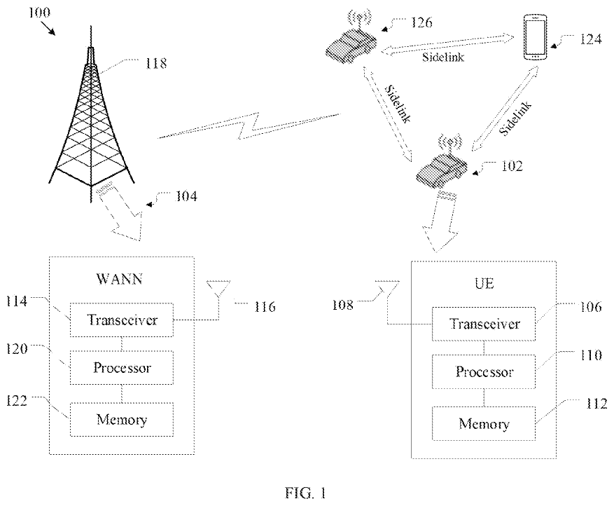

FIG. 1 shows an example system diagram of wireless communication network 100 including UEs 102, 124, and 126 as well as a wireless access network node (WANN) 104 according to various embodiments. A wireless access network provides network connectivity between the UEs 102, 124, and/or 126 and an information or data network such as a text, voice or video communication network, the Internet, and the like. An example wireless access network may be based on cellular technologies, which may further be based on, for example, 4G, Long Term Evolution (LTE), 5G, New Radio (NR), and/or New Radio Unlicensed (NR-U) technologies and/or formats. The UEs 102, 124, and 126 may include but are not limited to, a mobile phone, smartphone, tablet, laptop computer, a vehicle on-board communication equipment, roadside communication equipment, smart electronics or appliances such an air conditioner, a television, a refrigerator, an oven, or other devices that are capable of communicating wirelessly over a network. The UEs 102, 124, and 126 may directly communicate with each other via the sidelinks. For example, UE 102 may include transceiver circuitry 106 coupled to an antenna 108 to effect wireless communication with the wireless access network node 104. The transceiver circuitry 106 may also be coupled to a processor 110, which may also be coupled to a memory 112 or other storage devices. The memory 112 may store therein instructions or code that, when read and executed by the processor 110, cause the processor 110 to implement various ones of the methods described herein.

Similarly, the wireless access network node (WANN) 104 may comprise a base station or other wireless network access points capable of communicating wirelessly over a network with one or more UEs. For example, the wireless access network node 104 may comprise a 4G LTE base station, a 5G NR base station, a 5G central-unit base station, or a 5G distributed-unit base station. Each type of these wireless access network nodes may be configured to perform a corresponding set of wireless network functions. The set of wireless network functions between different types of wireless access network nodes may not be identical. The set of wireless network functions between different types of wireless access network nodes, however, may functionally overlap. The wireless access network node 104 may include transceiver circuitry 114 coupled to an antenna 116, which may include an antenna tower 118 in various approaches, to effect wireless communication with the UEs 102, 124, and 126. The transceiver circuitry 114 may also be coupled to one or more processors 120, which may also be coupled to a memory 122 or other storage devices. The memory 122 may store therein instructions or code that, when read and executed by the processor 120, cause the processor 120 to implement various ones of the methods described herein.

For simplicity and clarity, only one WANN 104 and three UEs 102, 124, and 126 are shown in the wireless communication network 100. It will be appreciated that one or more WANNs may exist in the wireless communication network, and each WANN may serve one or more UEs in the meantime. Besides UEs and WANNs, the network 100 may further comprise any other network nodes with different functions such as the network nodes in core network of the wireless communication network 100. In addition, while various embodiments will be discussed in the context of the particular example wireless communication network 100, the underlying principle applies to other applicable wireless communication networks.

In the sidelink communication such as V2X communication between UEs, the UEs monitor the sidelink signals within the entire range of sidelink receive resource pool, which can result in large power consumption and reduced efficiency. One of the objectives of the present disclosure is to reduce the power consumption of the sidelink communication while meeting the time delay requirements.

One manner of reducing power consumption when using sidelink (SL) communication between UEs is to utilize discontinuous reception (DRX) and/or discontinuous transmission (DTX) methodologies. However, such SL DRX requires that the transmission UE and reception UE at least know the DRX configuration of the corresponding UE. DRX configuration information may include, for example, a delay (e.g., sl-drx-SlotOffset) before starting an on duration timer (e.g., sl-drx-onDurationTimer); the on duration timer (e.g., sl-drx-onDurationTimer), which is the duration at the beginning of an SL DRX cycle; a subtrame where the SL DRX cycle starts (sl-drx-StartOffset); and the SL DRX cycle (sl-drx-Cycle). This disclosure discusses methods in which these configurations are determined and communicated amongst UEs.

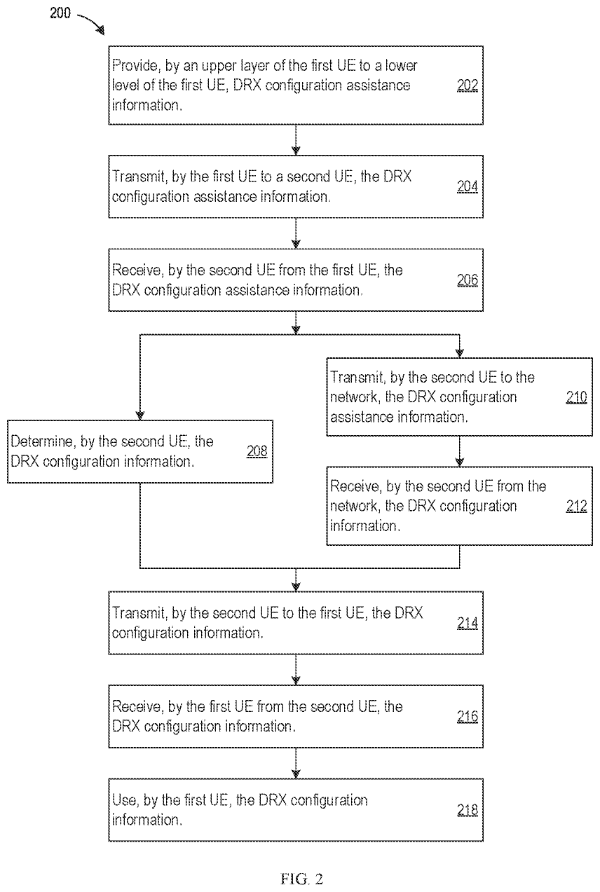

FIG. 2 illustrates an exemplary method 200 for sidelink communication between UEs. In particular, the method 200 may be performed by a first UE (e.g., 102) and a second UE (e.g., 124) in the wireless communication network 100. In various examples, the first UE 102 may be a receiving (RX) UE, and the second UE 124 may be a transmitting (TX) UE. In accordance with this embodiment, the second UE 124 (e.g., the TX UE) may determine the DRX configuration.

At 202, an upper layer of the first UE 102 provides to a lower level of the first UE 102 DRX configuration assistance information. In various embodiments, the DRX configuration assistance information may include, for example, SL DRX cycle information, and more specifically, may include a Downlink DRX configuration of the first UE 102. The DRX configuration assistance information may also include DRX cycle information and at least one of a layer-2 ID, an identification of another UE, quality of service (Qos) information, or Qos flow identity. In various embodiments, the Qos information may include at least one of a Qos flow ID, an SL-QoS-Profile, and/or a PQI. In certain approaches, the upper layer of the first UE 102 may provide to the lower level of the first UE 102 the DRX configuration assistance information along with at least one of a layer-2 ID, an identification of another UE, quality of service (Qos) information, or a Qos flow identity.

Further, in one example, the upper layer of the first UE 102 provides the SL DRX cycle information for each Qos flow. Then, Qos flows with the same cycle may be mapped to the same SL DRB (dedicated radio bearer). If there are more than one SL cycles for a destination ID, then the first UE 102 may select the shortest SL DRX cycle for the particular destination ID. Put another way, the first UE may determine a shortest DRX cycle of a plurality of DRX cycle configurations associated with the same destination layer-2 ID as the DRX cycle information of the destination layer-2 ID.

At 204, the first UE 102 transmits to a second UE (e.g., 124) the DRX configuration assistance information. For example, the first UE 102 may send the SL DRX cycle information along with the layer-2 IDs to the second UE 124. More specifically, after the first UE 102 establishes a PC5 link with the second UE 124, the first UE 102 may send the SL DRX cycle information to the second UE 124. At 206, the second UE 124 receives from the first UE 102, the DRX configuration assistance information.

At 208, the second UE 124 may determine the DRX configuration information based, at least in part, on the DRX configuration assistance information received from the first UE 102 and a traffic pattern of the second UE 124. In one approach, the second UE 124 determines the SL DRX configuration (such as the sl-drx-SlotOffset, sl-drx-onDurationTimer, or sl-drx-StartOffset) according to its traffic pattern and the SL DRX cycle of the first UE 102.

Alternatively, in certain approaches when the second UE 124 is in a Radio Resource Control (RRC) connected state, at 210, the second UE 124 transmits to a network (e.g., to a serving cell or a wireless access network node) the DRX configuration assistance information, which may include the SL DRX cycle of the first UE 102, the traffic pattern of the second UE 124, and/or other information. Then, the network may decide the SL DRX configuration information according to the traffic pattern of the second UE 124 and the current SL DRX cycle of the first UE 102. At 212, the second UE 124 receives back from the network the DRX configuration information for the first UE 102.

At 214, the second UE 124 may transmit to the first UE 102 the DRX configuration information comprising DRX-related parameters for a sidelink communication between the first UE 102 and the second UE 124, or between a pair of source layer-2 ID and destination layer-2 ID. In various embodiments, the DRX configuration information comprises at least one of DRX slot offset information, DRX on duration timer information, DRX start offset information, and/or DRX cycle information. At 216, the first UE 102 may receive from the second UE 124 the DRX configuration information.

At 218, the first UE 102 may use a SL DRX configuration based on the received SL DRX configuration information with an associated destination ID. In various examples, the first UE 102 may only update the SL DRX configuration for the link between the first UE 102 and the second UE 124 with the DRX configuration information.

In an alternative embodiment, the first UE 102 may send its suggested SL DRX configuration to the second UE 124. Further, the first UE 102 may have multiple SL DRX configurations for different links. To avoid an issue where different TX UEs configure non-overlapping wake-up time for the same RX UE, which undercuts the power saving purposes of DRX, the first UE 102 can send part or all of the SL DRX configurations to the second UE 124. As such, in this alternative embodiment, the DRX configuration assistance information may include a plurality of existing DRX configurations for a plurality of sidelink communications associated with at least one different PC5 link or destination Layer-2 ID of the first UE 102.

For example, after the first UE 102 establishes a PC5 link with the second UE 124, the first UE 102 may send its SL DRX configuration to the second UE 124. For example, the suggested SL DRX configuration can be the current SL DRX configuration for other PC5 links and/or for groupcasts and/or broadcast. Aa destination Layer-2 ID can be associated with a sidelink unicast link, a sidelink boardcast link, or a sidelink groupcast link.

In one approach, the second UE 124 may decide the SL DRX configuration according to its traffic pattern and the current SL DRX configuration of the first UE 102. For example, the second UE 124 may determine the SL DRX configurations of the first UE for the link between the first UE and the second UE. The second UE 124 then may send the SL DRX configuration to the first UE 102.

Alternatively, in another approach, if the second UE 124 is in RRC connected state, it may send the SL DRX configuration of the first UE and/or other information to the network. Then, network may decide the SL DRX configuration according to the traffic pattern of the second UE 124 and the current SL DRX configuration of the first UE 102 and send the updated SL DRX configuration of the first UE to the second UE. Then, the second UE sends the SL DRX configuration to the first UE.

In various embodiments, if the second UE 124 can accept the received SL DRX configuration of the first UE 102, it can simply send indication information to the first UE 102 to indicate the received SL DRX configuration (from the first UE 102) is confirmed. In this instance, the second UE 124 may not send the updated SL DRX configuration to the first UE 102.

Upon receipt of the DRX configuration information from the second UE 124, the first UE 102 may update its SL DRX configuration based on the received SL DRX configuration for the associated destination ID. In various examples, the first UE 102 may only update the SL DRX configuration for the link between the first UE 102 and the second UE 124 with the DRX configuration information.

In certain embodiments, when determining its suggested DRX configuration to send to the second UE 124, the first UE 102 may consider a default DRX configuration as its SL DRX configuration to send to the second UE 124. In such an instance, the DRX configuration assistance information may include a default DRX configuration of the first UE 102.

In one approach, for example, if the first UE 102 is in coverage of the network, the first UE 102 may receive from the network a mapping between a plurality of Qos requirements and at least one of a set of DRX configuration parameters or an index of the set of DRX configuration parameters. From this mapping, the first UE 102 may then determine the default DRX configuration based on a Qos requirement and the mapping.

Alternatively, if the first UE 102 is out of coverage of the network, the first UE 102 may determine the default DRX configuration based on a Qos requirement and a preconfigured mapping between a plurality of Qos requirements and at least one of a set of DRX configuration parameters or an index of the set of DRX configuration parameters. From this preconfigured mapping, the first UE 102 may then determine the default DRX configuration based on a Qos requirement and the mapping.

In another embodiment, which may be utilized for any of unicast, groupcast, or broadcast configurations, a method performed by the first UE 102 includes providing, by an upper layer of the first UE 102 to a lower level of the first UE 102, DRX cycle, optionally along with at least one of a layer-2 ID, an identification of another UE, quality of service (Qos) information, or a Qos flow identity. The method also includes receiving, by the first UE 102 from the network 100, multiple DRX configuration information comprising DRX-related parameters for different DRX cycles for a sidelink communication for unicast, groupcast, or broadcast. For example, the multiple different DRX configuration information may be mapped to different DRX cycles. The first UE 102 then determines the DRX-related parameters based on the DRX cycle that was provided from its upper layer and the received multiple DRX configuration information. Then, the first UE 102 may perform sidelink reception on the time occasion according to the determined DRX-related parameters. The lower level of the first UE 102 may be the AS level of the first UE 102.

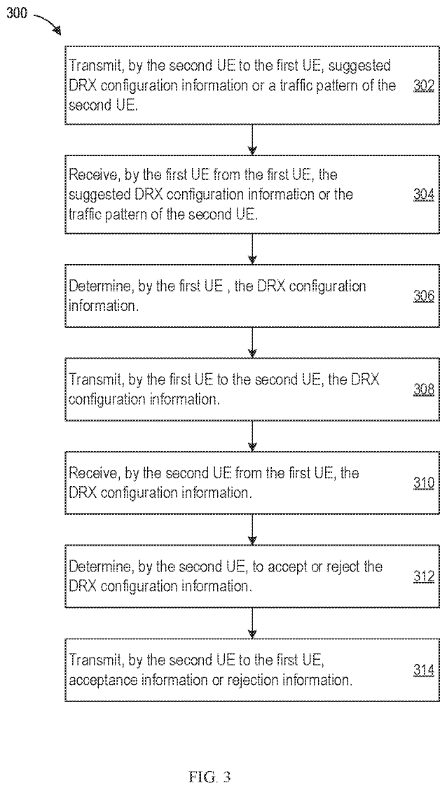

FIG. 3 illustrates another exemplary method 300 for sidelink communication between UEs. In particular, the method 300 may be performed by a first UE (e.g., 102) and a second UE (e.g., 124) in the wireless communication network 100. In various examples, the first UE 102 may be a receiving (RX) UE, and the second UE 124 may be a transmitting (TX) UE. In accordance with this embodiment, the first UE 102 (e.g., the RX UE) may determine the DRX configuration.

At 302, the second UE 124 transmits to the first UE 102 suggested or expected DRX configuration information and/or a traffic pattern of the second UE. Correspondingly, at 304, the first UE 102 receives from the second UE 124 the suggested DRX configuration information or the traffic pattern of the second UE 124.

At 306, the first UE 102 determines the DRX configuration information comprising DRX-related parameters for a sidelink communication between the first UE and the second UE or between a pair of source layer-2 ID and destination layer-2 ID. If the first UE 102 is in RRC connected state, it may send the suggested DRX configuration and/or the traffic pattern information received from the second UE 124 to its serving cell. Additionally, the suggested DRX configuration information from the second UE 124 may include more than one suggested DRX configuration, where each suggested DRX configuration may be associated with a destination ID.

In one approach, the upper layer of the first UE 102 may provide SL DRX cycle information along with the layer-2 IDs to the lower layer of the first UE 102. Alternatively, the upper layer of the first UE 102 may provide the SL DRX cycle information along with the Qos information to the lower layer of the first UE 102. In various embodiments, the Qos information may include Qos flow ID, SL-QoS-Profile, and/or PQI. Optionally, the upper layer of the first UE 102 may provide the SL DRX cycle information for each Qos flow. Then the Qos flows with the same cycle may be mapped to the same SL DRB. If there are more than one SL DRX cycles for a destination ID, the first UE 102 may select the shortest SL DRX cycle for this destination ID.

If the first UE 102 is in RRC connected state, it can send the suggested DRX configuration and the SL DRX cycle information to the serving cell. To be specific, the SL DRX cycle information can be included in sidelink UE information and indicated for each destination ID or indicated for each Qos flow. The first UE 102 may then receive the DRX configuration information from the serving cell. Optionally, if the DRX configuration includes more than one DRX configuration, each DRX configuration may be associated to one destination ID.

Alternatively, if the first UE 102 is in RRC idle or is out of coverage of the network, it may decide the DRX configuration based on the suggested DRX configuration or the SL traffic pattern information for the associated destination ID from the second UE 124.

As mentioned above, in one approach, the upper layer of the first UE 102 may provide SL DRX cycle information along with the layer-2 IDs to the lower layer of the first UE 102. Alternatively, the upper layer of the first UE 102 may provide the SL DRX cycle information along with the Qos information to the lower layer of the first UE 102. Optionally, the upper layer of the first UE 102 may provide the SL DRX cycle information for each Qos flow. Then the Qos flows with the same cycle may be mapped to the same SL DRB. If there are more than one SL DRX cycles for a destination ID, the first UE 102 may select the shortest SL DRX cycle for this destination ID. Then, the first UE 102 may decide the DRX configuration based on the suggested DRX configuration and the SL DRX cycle for the destination ID.

In either approach (RRC connected or not), the first UE 102 may receive from the second UE 124 the traffic pattern of the second UE 124, and then determine an active time of the DRX configuration scheme to include all of the time indicated in the traffic pattern of the second UE 124.

At 308, the first UE 102 transmits to the second UE 124 the DRX configuration information including the DRX-related parameters for the sidelink communication between the first UE 102 and the second UE 124 or between a pair of source layer-2 ID and destination layer-2 ID. Correspondingly, at 310, the second UE 124 may receive from the first UE102 the DRX configuration information.

At 312, the second UE 124 may determine to either accept or reject the DRX configuration information from the first UE 102. In a approach, when the second UE 124 is in a RRC connected state, it may transmit to the network the DRX configuration information from the first UE 102. Then, the second UE 124 may receive a network acceptance or a network rejection of the DRX configuration information from the network. If the second UE 124 can use the DRX configuration information from the first UE 102, it can update its DRX configuration accordingly.

In another approach, the second UE 124 may determine to accept or reject the DRX configuration information from the first UE 102 itself. In one example, the second UE 124 may determine to reject the DRX configuration information from the first UE 102 if the second UE cannot find an available transmission resource during an active time of the DRX configuration scheme. In another example, the second UE 124 may determine to reject the DRX configuration information from the first UE 102 if the second UE cannot meet a latency requirement during an active time of the DRX configuration scheme.

At 314, the second UE 124 transmits to the first UE 102 (and the first UE 102 receives from the second UE 124) either acceptance information indicating an acceptance of the DRX configuration information to confirm the DRX configuration, or rejection information indicating a rejection of the DRX configuration information. This acceptance information or rejection information may be from the result of the second UE 124 inquiring to the network when it is RRC connected, or from a determination performed by the second UE 124 itself, both as discussed above.

If the second UE 124 determines to reject the DRX configuration information from the first UE 102, the second UE 124 may transmit to the first UE 102 (and the first UE 102 may receive from the second UE 124) suggested DRX configuration information along with the rejection information. In a specific approach, the second UE 124 may include the suggested DRX configuration information in the rejection information. In another approach, the second UE may transmit to the first UE (and the first UE 102 may receive from the second UE 124) a cause value indicating a reason for the rejection along with the rejection information. Again, in a specific approach, the second UE 124 may include the cause value in the rejection information. The cause value may indicate that the second UE 124 cannot find an available transmission resource during an active time of the DRX configuration scheme or cannot meet a latency requirement during an active time of the DRX configuration scheme.

If the first UE 102 receives this rejection information, the first UE 102 can update the DRX configuration (e.g., using the suggested DRX configuration information) and can iteratively perform the above steps again.

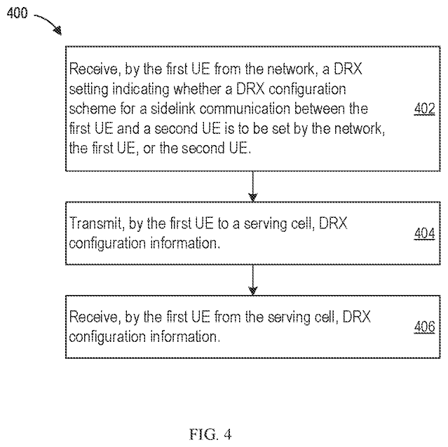

FIG. 4 illustrates another exemplary method 400 for sidelink communication between UEs. In particular, the method 400 may be performed by a first UE (e.g., 102) and/or a second UE (e.g., 124) in the wireless communication network 100. In various examples, the first UE 102 may be either a receiving (RX) or transmitting (TX) UE, and the second UE 124 may also be a receiving (RX) or transmitting (TX) UE. In accordance with this embodiment, the first UE 102 determines the DRX configuration (either directly or via the network when RRC connected).

At 402, the first UE 102 receives from the network a DRX setting indicating whether a DRX configuration scheme for a sidelink communication between the first UE 102 and a second UE 124 is to be set by the network, the first UE 102, or the second UE 124. If the DRX setting indicates that the SL DRX configuration is decided by the first UE 102 or the second UE 124, that UE decides the SL DRX configuration. Conversely, if the DRX setting indicates the SL DRX configuration is decided by the network, the network decides the SL DRX configuration.

If the DRX setting indicates that the DRX configuration related parameters are to be set by the network, at 404, the first UE 102 may transmit to a serving cell DRX configuration assistance information. The DRX configuration assistance information may include at least one of a suggested DRX configuration scheme or a DRX cycle acquired from an upper level of the first UE 102. At 406, the first UE 102 may receive from the serving cell DRX configuration information comprising the DRX-related parameters for the sidelink communication between the first UE 102 and the second UE 124 or between a pair of source layer-2 ID and destination layer-2 ID.

In various approaches, if the first UE 102 is RRC connected, if the UE is configured with sl-ScheduledConfig, which indicates the configuration for UE to transmit NR sidelink communication based on network scheduling, then the network may decide the SL DRX configuration of its own or the peer UE. Also, if the first UE 102 is configured with sl-UE-SelectedConfig, which indicates the configuration used for UE autonomous resource selection, then the first UE 102 may decide the SL DRX configuration of its own or the peer UE.

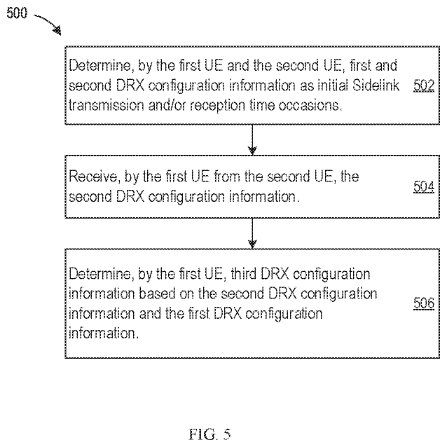

FIG. 5 illustrates another exemplary method 500 for sidelink communication between UEs. In particular, the method 500 may be performed by a first UE (e.g., 102) and/or a second UE (e.g., 124) in the wireless communication network 100. In various examples, the first UE 102 may be either a receiving (RX) or transmitting (TX) UE, and the second UE 124 may also be a receiving (RX) or transmitting (TX) UE. In accordance with this embodiment, the first UE 102 determines the DRX configuration (either directly or via the network when RRC connected).

Considering that most traffic on the network 100 is based on TCP protocol, the transmission for feedback is needed when the first UE 102 receives the data. As such, it is desirable that the TX occasions align with the RX occasions in order to increase power efficiency. In this embodiment, the first UE 102 can decide a DRX configuration that is used for both transmission and reception.

In accordance with various embodiments, the UE determines the initial SL DTX (transmission time occasions) and/or DRX (reception time occasions). In some examples, the SL DRX is the same as the SL DTX. Then, the TX UE and RX UE exchange their initial SL DRX configuration and/or SL DTX configuration. Each UE may update their SL DRX configuration and/or SL DTX configuration. In one example, the updated transmission time occasions may be the union of transmission/reception time occasions of both the TX UE and RX UE. Similarly, the updated reception time occasions may be the union of transmission/reception time occasions of both the TX UE and the RX UE.

At 502, the first UE 102 may determine first DRX configuration information as initial Sidelink transmission and/or reception time occasions, and the second UE 124 may determine second DRX configuration information as initial Sidelink transmission and/or reception time occasions. For example, the AS layer of each UE 124 may acquire the SL DRX cycle information from the NAS layer of the corresponding UE, and then each UE may determine the time where the SL DRX cycle starts and/or sl-drx-onDurationTimer and/or the delay before starting the sl-drx-onDurationTimer. Then the first UE 102 establishes the PC5 link with the second UE 124 if there is no PC5 link between the first UE 102 and the second UE 124.

At 504, the first UE 102 receives from the second UE 124 the second DRX configuration information comprising second DRX-related parameters of the second UE. Again, this DRX configuration information may include the initial Sidelink transmission and/or reception time occasions configuration information.

At 506, the first UE 102 determines third DRX configuration information based on the second DRX configuration information from the second UE 124 and the first DRX configuration information comprising first DRX-related parameters of the first UE. The third DRX configuration information may include updated DRX related parameters associated with transmission time occasion and/or updated DRX related parameters associated with reception time occasion. In various embodiments, the updated transmission time occasion may be a union of at least one of transmission or reception time occasions of the first DRX configuration and the second DRX configuration. Similarly, the updated reception time occasion may be a union of at least one of transmission or reception time occasions of the first DRX configuration and the second DRX configuration.

In various embodiments, the first UE may determine that the third DRX configuration information is different from the second DRX configuration information. If so, the first UE may transmit to the second UE the third DRX configuration information comprising the third DRX-related parameters. Upon receipt, the second UE 124 may perform the above-described process to determine a fourth DRX configuration, and determine if it is the same as the third DRX configuration received from the first UE 102. If it is the same, the second UE 124 may implement the third/fourth DRX configuration (and may further transmit an acknowledgement back to the first UE 102). If not, the process may continue back and forth iteratively until an acceptable DRX configuration is determined.

In accordance with the various methods and embodiments disclosed above, various technical advantages are realized. Primarily, improved methods and devices for implementing sidelink DRX configurations are disclosed, which result in improved UE energy efficiency.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed by a first user equipment (UE) in a wireless communication network, the method comprising:
providing, by an upper layer of the first UE to a lower level of the first UE, discontinuous reception (DRX) configuration assistance information;
transmitting, by the first UE to a second UE, the DRX configuration assistance information; and
receiving, by the first UE from the second UE, DRX configuration information comprising DRX-related parameters for a sidelink communication between the first UE and the second UE or between a pair of source layer-2 ID and destination layer-2 ID.

2. (canceled)

3. The method of claim 1,
wherein the DRX configuration assistance information comprises DRX cycle information, and
wherein the method comprises:
determining, by the first UE, a shortest DRX cycle of a plurality of DRX cycle configurations associated with the same destination layer-2 ID as the DRX cycle information of the destination layer-2 ID.

4. The method of claim 1, wherein the DRX configuration information comprises at least one of DRX slot offset information, DRX on duration timer information, DRX start offset information, or DRX cycle information.

5. The method of claim 1, wherein the DRX configuration assistance information comprises a plurality of existing DRX configurations for a plurality of sidelink communications associated with at least one different PC5 link or destination Layer-2 ID.

6. (canceled)

7. The method of claim 1,
wherein the DRX configuration assistance information comprises a default DRX configuration of the first UE, and
wherein the method comprises:
receiving, by the first UE from a network, a mapping between a plurality of Qos requirements and at least one of a set of DRX configuration parameters or an index of the set of DRX configuration parameters; and
determining, by the first UE, the default DRX configuration based on a Qos requirement and the mapping.

8. The method of claim 1,
wherein the DRX configuration assistance information comprises a default DRX configuration of the first UE, and
wherein the method comprises:
determining, by the first UE, the default DRX configuration based on a Qos requirement and a preconfigured mapping between a plurality of Qos requirements and at least one of a set of DRX configuration parameters or an index of the set of DRX configuration parameters.

9. The method claim 1, wherein the DRX configuration assistance information comprises a Downlink DRX configuration of the first UE.

10. The method of claim 1, wherein the first UE is a receiving (RX) UE, and wherein the second UE is a transmitting (TX) UE.

11. The method of claim 1, further comprising:
providing, by the upper layer to the lower level of the first UE, the DRX configuration assistance information along with at least one of a layer-2 ID, an identification of another UE, quality of service (Qos) information, or Qos flow identity.

12-43. (canceled)

44. A first user equipment (UE) comprising:
a memory storing computer code instructions; and
a processor configured to communicate with the memory and to execute the computer code instructions to cause the first UE to perform a method comprising:
providing, by an upper layer of the first UE to a lower level of the first UE, discontinuous reception (DRX) configuration assistance information;
transmitting, to a second UE, the DRX configuration assistance information; and
receiving, from the second UE, DRX configuration information comprising DRX-related parameters for a sidelink communication between the first UE and the second UE or between a pair of source layer-2 ID and destination layer-2 ID

45. The first UE according to claim 44,
wherein the DRX configuration assistance information comprises DRX cycle information, and
wherein the processor is configured to execute the computer code instructions to cause the first UE to perform the method further comprising:
determining a shortest DRX cycle of a plurality of DRX cycle configurations associated with the same destination layer-2 ID as the DRX cycle information of the destination layer-2 D.

46. The first UE according to claim 44,
wherein the DRX configuration assistance information comprises a default DRX configuration of the first UE, and
wherein the processor is configured to execute the computer code instructions to cause the first UE to perform the method further comprising:
receiving, by the first UE from a network, a mapping between a plurality of Qos requirements and at least one of a set of DRX configuration parameters or an index of the set of DRX configuration parameters; and
determining, by the first UE, the default DRX configuration based on a Qos requirement and the mapping.
